(19) United States
(12) Patent Application Publication
(10) Pub. No.: US 2026/0010192 A1
(43) Pub. Date: Jan. 8, 2026

(54) DEVICE AND METHOD FOR SYNCHRONISING OR ADJUSTING A CLOCK SIGNAL OF A SOFTWARE

(71) Applicant: Liebherr-Aerospace Lindenberg GmbH, Lindenberg (DE)

(72) Inventor: Thomas DEDLER, Lindenberg (DE)

(21) Appl. No.: 19/261,357

(22) Filed: Jul. 7, 2025

(30) Foreign Application Priority Data
Jul. 8, 2024 (DE) 10 2024 119 292.5

(51) Int. Cl. G06F 1/08; G06F 1/14

(52) U.S. Cl. CPC G06F 1/08; G06F 1/14

(57) ABSTRACT

A device for synchronising a clock signal for a software comprises a processor for executing the software based on the clock signal, a measurement timer module that increments a timer value based on a device clock, an output unit designed to output a signal at the start of a synchronisation period defined by the software period or a multiple thereof, an input unit, a register unit designed to store a current timer value of the measurement timer module at the end of a synchronisation period, and a comparison unit designed to compare the timer value stored in the register unit with the synchronisation period, and, depending on a comparison result, to adjust at least one subsequent period duration of the clock signal for the software executed on the processor. The measurement timer module is designed to reset the timer value to a start value when an input signal is received.

### CROSS REFERENCE TO RELATED APPLICATION

The present application claims priority to German Patent Application No. 10 2024 119 292.5 filed on Jul. 8, 2024. The entire contents of the above-listed application are hereby incorporated by reference for all purposes.

### TECHNICAL FIELD

The present disclosure relates to a device and a method for synchronising or adjusting a clock signal of a software, and to a corresponding system for this purpose.

### BACKGROUND

For safety reasons, it is often advantageous if several instances of one and the same software or even differently designed software programs are executed on independent processors, e.g. in order to execute critical functions redundantly and as decoupled as possible from each other when controlling or monitoring a vehicle or aircraft.

### SUMMARY

However, it is advantageous if the different software programs are executed synchronously with each other. However, as the internal clocks of different computer units can never be operated completely synchronised with each other due to existing tolerances, the clock signals of the respective computer units shift over time, which disrupts the time synchronisation of the different software programs on the respective computer units.

Typical areas of application for the time-synchronised operation of software on different computer units or controllers or processors is the redundant provision of critical functions implemented by software. However, the concept of the present disclosure can just as well be integrated into a control/monitor architecture in which the time-synchronised execution of different software programs is also important

In real-time applications, the control software is usually executed with a fixed period of a few milliseconds. If two controllers run asynchronously, the time taken to transfer the data between the controllers can fluctuate (jitter) by the period duration of the software. This must be taken into account when designing the system, which involves additional work.

The jitter caused by the asynchronous execution of the software also impairs the response time to external events that require coordination between the controllers.

Various prior art protocols are available for synchronising the time base at application level, such as the network time protocol (NTP) and the precision time protocol (PTP). These protocols enable the synchronisation of network participants via a digital bus. The disadvantage of this is that synchronisation by means of a protocol increases the effort and runtime of the software for communication processing, leaving less time for the actual control tasks. In addition, the transmission time via the bus limits the achievable accuracy.

It is the aim of the present disclosure to create a device, a method or a system that overcomes or at least mitigates the disadvantages listed above. In particular, the aim of the present disclosure is to synchronise the start time of a software period on two independent controllers with as little computing time and as high a degree of accuracy (≤1 μs) as possible.

This is achieved with a device, system, and/or method having the features described herein.

According to the disclosure, a device, for example a microcontroller, is provided for synchronising or adjusting a clock signal for a software, which comprises a processor for executing the software based on the clock signal, wherein the clock signal defines the start or the end of a software period, a measurement timer module that increments a timer value based on a device clock, an output unit designed to output an output signal to a signal output of the device at the start of a synchronisation period defined by the software period or a multiple of the software period, an input unit designed to receive an input signal at a signal input of the device, and a register unit designed to store a current timer value of the measurement timer module at the end of a synchronisation period, wherein the measurement timer module is designed to reset the timer value to a start value, for example to zero, when an input signal is received. The disclosure is characterised by a comparison unit designed to compare the timer value stored in the register unit with the synchronisation period and, depending on a comparison result, to adjust at least one subsequent period duration of the clock signal for the software executed on the processor, for example to lengthen or shorten it.

The device, or the microcontroller, is able to reset a timer value (or counter value) depending on an input signal, wherein the signal received via the input unit can indicate the start of a synchronisation period of another entity. This tells the device the amount by which the synchronisation period clocked by it is offset from a synchronisation period of the other entity, so that the synchronisation period can be adjusted depending on the offset determined.

This makes it possible to restore synchronisation between the two synchronisation periods of different devices, which reduces the jitter that can otherwise occur due to asynchronous execution of different instances of the same software when comparing the output signals of the software. Furthermore, according to the disclosure, no protocol-based synchronisation is necessary, since the advantages of the device described above do not require a protocol.

In addition, a device, for example a microcontroller, may also be provided according to the disclosure for synchronising or adjusting a clock signal for a software, which comprises a processor for executing the software based on the clock signal, wherein the clock signal defines the start or the end of a software period, a measurement timer module that increments a timer value based on a device clock, an output unit designed to output an output signal to a signal output of the device at the start of a synchronisation period defined by the software period or a multiple of the software period, an input unit designed to receive an input signal at a signal input of the device, and a register unit designed to store a current timer value of the measurement timer module when an input signal is received, wherein the measurement timer module is designed to reset the timer value to a start value, for example to zero, at the start of a synchronisation period. The disclosure is characterised by a comparison unit designed to compare the timer value stored in the register unit with the synchronisation period and, depending on a comparison result, to adjust at least one subsequent period duration of the clock signal for the software executed on the processor, for example to lengthen or shorten it.

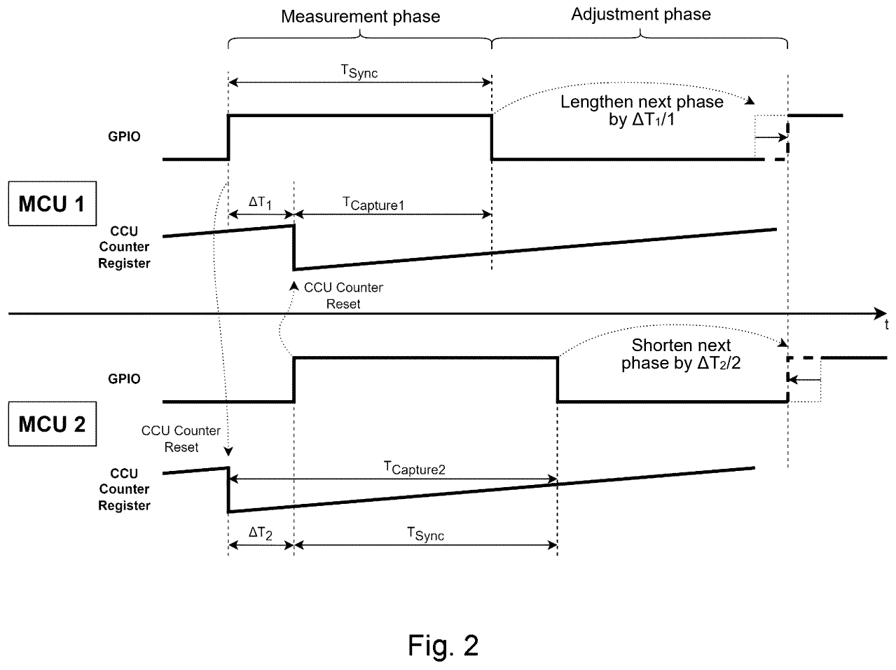

FIG. 2 shows that ΔT is now determined directly instead of T_{Capture}, wherein synchronisation is present if the timer value of the measurement timer module is 0 or a value that deviates only slightly therefrom.

According to an optional development of the present disclosure, it can be provided that the device clock has a frequency that is greater than the frequency of the clock for executing the software executed on the processor, optionally wherein the frequency of the device clock is more than 100 times, optionally more than 1000 times greater than the frequency of the clock for executing the software executed on the processor.

The device clock typically corresponds to the computing clock of the processor of the device and is in the range of several 100 MHz or several gigahertz for microcontrollers known from the prior art.

The clock signal for the software executed by the processor must be distinguished from this, as this typically has a significantly lower frequency than the device clock. It is therefore no problem to record or specify the software period or the synchronisation period as a multiple of the device cycle. A timer module, which is incremented with each device cycle, can therefore determine the duration of the software period or the synchronisation period or a subsection thereof quite precisely.

According to one possible embodiment of the present disclosure, it can be provided that the comparison unit is designed to lengthen or shorten the subsequent period duration of the clock signal for the software executed on the processor by half the time difference determined by the comparison result, depending on the comparison result.

Thus, if an offset at the start of the synchronisation period is detected with the device according to the disclosure, wherein a start of the synchronisation period of another device has been communicated via the input unit, the entire offset does not necessarily have to be compensated for in one of the devices compared with one another, but according to this advantageous implementation, each of the two devices can also compensate for half of the offset, such that a subsequent start of the synchronisation period of the devices compared with one another starts again simultaneously.

However, the compensation can also be implemented in only one of the several devices due to the offset determined.

According to a further optional development of the present disclosure, it may be provided that the comparison unit is designed to lengthen or shorten several subsequent period durations of the clock signal for the software executed on the processor by a fraction of the time difference determined by the comparison result, depending on the comparison result, optionally wherein the fraction is

$$\frac{1}{2 N} or \frac{1}{N}$$

wherein N is the number of subsequent period durations of the clock signal to be lengthened or shortened for the software executed on the processor.

If we assume that different software programs are to be synchronised with each other, it is often the case that the software periods to be synchronised with each other have different durations. In such a case, the synchronisation period is the least common multiple of the two software periods of different lengths. If a deviation is detected in the synchronisation comparison, it is advantageous not to compensate for this synchronisation offset within a single software period, as the degree of compensation, i.e. the deviation from an uncorrected software period, is significantly greater than if the desired compensation is implemented over several software periods.

For this reason, it is suggested that the deviation detected over the synchronisation period should not be compensated for within a single software period, but that the entire number of available software periods (within a synchronisation period) should be used. The factor of 0.5 results, as already explained above, from the consideration that the other device with which synchronisation is to be achieved also compensates for its synchronisation period in equal parts.

It can further be provided that the comparison unit is designed to divide the timer value stored in the register unit by a frequency characterising the device cycle in order to obtain a measurement period.

As the timer value represents one period of the device clock, the duration measured with the timer value can be obtained by dividing the clock frequency of the processor (=device clock frequency).

According to an optional development of the present disclosure, it can be provided that the device further comprises an internal clock timer module that increments a timer value based on the device clock and outputs an interrupt signal when a preset timer target value is reached, wherein the preset timer value divided by the frequency of the device cycle gives the software period, and the comparison unit is designed to execute the following at least one period duration of the clock signal for the software executed on the processor by adjusting the timer target value.

The interrupt signal output then signals the end of the software period. In order to adjust the duration of the software period according to the above considerations, i.e. to shorten or lengthen it, the timer target value is varied accordingly. If a software period needs to be lengthened to achieve synchronisation, the previously used timer target value is increased (once). Conversely, if a software period needs to be shortened to achieve synchronisation, the previously used timer target value is reduced (once).

According to one embodiment of the present disclosure, it may further be provided that the input unit is implemented by a capture/compare unit (CCU), which is configured in capture mode, and/or the output unit is implemented by a general-purpose input/output unit (GPIO).

A capture/compare unit (CCU) is a special functional unit in microcontrollers and other digital signal processors that is used to accurately capture and process signals. This unit makes it possible to record and store specific times of external events and to perform comparison operations in order to realise precise time-controlled control tasks.

In capture mode, the CCU records the current timer value (or counter value) as soon as the end of the synchronisation period is detected, for example by detecting a falling edge of the synchronisation period. Furthermore, the CCU is configured so that it resets its integrated timer to zero when the input unit receives a specific input signal (e.g. a rising or falling edge).

A general-purpose input/output (GPIO) is a universally usable digital pin on microcontrollers and other integrated circuits that can be configured as both an input and an output. These pins provide a versatile interface for the interaction of a microcontroller with the outside world.

Configured as an output, a GPIO pin can control external devices, wherein the synchronisation signal characterising the synchronisation time of the associated microcontroller is output so that it can be picked up by another device via the input unit, for example the CCU.

The disclosure also relates to a system for synchronising or adjusting a clock signal of a plurality of software programs executed in parallel, comprising a first device according to one of the previously discussed embodiments, and a second device according to one of the previously discussed embodiments, wherein the output unit of the first device is connected to the input unit of the second device and the output unit of the second device is connected to the input unit of the first device, optionally wherein a respective software program of the plurality of software programs executed in parallel is executed by the respective processor of the plurality of devices.

This describes the advantageous interaction of several devices according to the disclosure as a system, in which the independently operated software programs of the individual devices can be synchronised with each other.

Optionally, it can be provided that the synchronisation period is the least common multiple of the software period of the first device and the software period of the second device.

The disclosure also relates to a method for synchronising or adjusting a respective clock signal for a plurality of software programs executed in parallel, for example with a device according to one of the embodiments set out above or a system according to one of the embodiments set out above, comprising the steps of:
defining a respective software period for the plurality of software programs to be synchronised with each other, which are executed by respective computer units, optionally as a multiple of a device cycle of a respective computer unit (processor), which executes an associated software program,
defining a synchronisation period as the least common multiple of the several respective software periods,
performing a time measurement, wherein the start time of the time measurement for a first computer unit is the start of the synchronisation period of a second computer unit and the end time of the time measurement for the first computer unit is the end of the synchronisation period of the first computer unit, and wherein the start time of the time measurement for a second computer unit is the start of the synchronisation period of a first computer unit and the end time of the time measurement for the second computer unit is the end of the synchronisation period of the second computer unit, wherein
each computer unit compares the result of the time measurement with the synchronisation period and adjusts, in particular lengthens or shortens, at least one subsequent synchronisation period as a function thereof.

Similar to the device, the method according to the disclosure also uses the start of the synchronisation period of another computer unit to reset a counter, so that a deviation of the own synchronisation period from the other synchronisation period can be detected at the end of the own synchronisation period. Depending on the deviation determined, the next synchronisation period is then extended or shortened in order to restore synchronisation with the other synchronisation period, which can also be lengthened or shortened accordingly.

The disclosure also relates to a method for synchronising or adjusting a respective clock signal for a plurality of software programs executed in parallel, for example with a device according to one of the embodiments set out above or a system according to one of the embodiments set out above, comprising the steps of:
defining a respective software period for the plurality of software programs to be synchronised with each other, which are executed by respective computer units, optionally as a multiple of a device cycle of a respective computer unit (processor), which executes an associated software program,
defining a synchronisation period as the least common multiple of the several respective software periods,
performing a time measurement, wherein the start time of the time measurement for a first computer unit is the start of the own synchronisation period and the end time of the time measurement for the first computer unit is the start of a synchronisation period of a second computer unit, and wherein the start time of the time measurement for a second computer unit is the start of the own synchronisation period and the end time of the time measurement for the second computer unit is the start of the synchronisation period of the first computer unit, wherein
each computer unit compares the result of the time measurement with the synchronisation period and adjusts, in particular lengthens or shortens, at least one subsequent synchronisation period as a function thereof.

According to another possible modification of the present disclosure, it can be provided that, if the software period is equal to the synchronisation period, the subsequent software period is then lengthened or shortened by half of the deviation determined in the comparison.

Alternatively or additionally, it can be provided that, if the software period is N times the synchronisation period, N subsequent software periods are each lengthened or shortened by

$$\frac{1}{2 N}$$

times the value or 1/N times the value determined in the comparison.

The factor of ½ can be omitted, for example, if only one of the two synchronised devices makes an adjustment and the other continues to operate without adjustment.

According to another possible embodiment of the present disclosure, it can be provided that a measured value determined in the comparison by the measurement timer module, the amount of which is greater than twice the synchronisation period, indicates that there is an error, optionally that the other parallel software program is inactive.

If the measured value determined by the time measurement is more than twice as large as the synchronisation period, there is an error, such that it is concluded that the other software program is no longer accessible or available.

According to another possible embodiment of the present disclosure, it can be provided that a sequence of comparison results obtained in the comparison is stored and analysed, and when a predetermined threshold value of the multiple comparison results is reached, a fault, for example an imminent loss of synchronisation, is inferred via a predetermined number of successively performed comparisons.

Thus, according to the present disclosure, it can also be provided that the measured value obtained during a time measurement is stored, so that a large number of stored measured values (T_{Capture}) are available over time, which can be subjected to an analysis. If it is detected that the measured value permanently exceeds or falls below a specified threshold value for a certain period of time, i.e. synchronisation must be ensured by adjusting the synchronisation period, this indicates that the deviation cannot be compensated for. It must then be assumed that one of the two software programs or devices to be operated synchronously does not (permanently) comply with the synchronisation period. The loss of synchronisation can therefore be detected very early, wherein it is not possible to determine which of the synchronously operating software programs or devices is the cause.

The disclosure also relates to an aircraft having a device according to one of the previously discussed embodiments, a system according to the previously discussed embodiments or a control unit for performing a method according to one of the previously discussed embodiments.

### DETAILED DESCRIPTION

Further features, details and advantages of the disclosure can be seen in the following description of the figures. In the drawings:

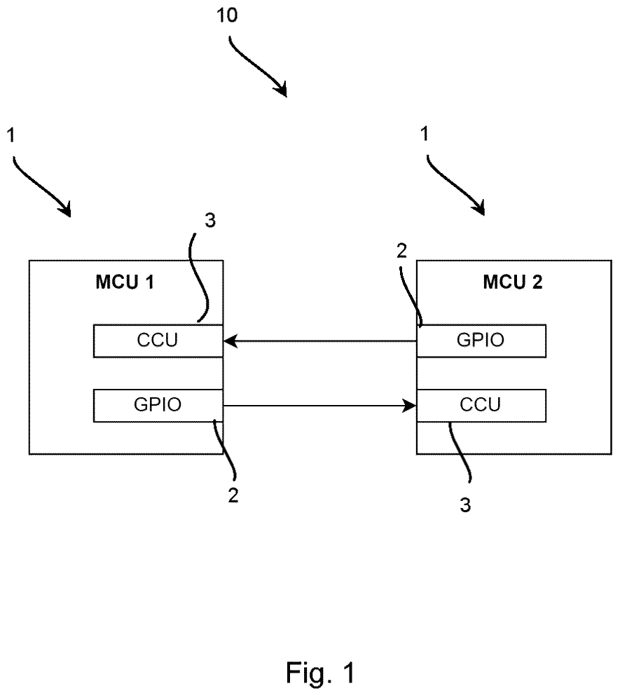

FIG. 1: shows a schematic representation of a system having two devices according to the disclosure, and

FIG. 2: shows diagrams showing the synchronisation period and the timer value incremented over time of the measurement timer module for the devices shown in FIG. 1.

### DETAILED DESCRIPTION

FIG. 1 shows a system 10 having two devices 1 according to the disclosure. According to the embodiment shown, each device 1 consists of a microcontroller (MCU1 and MCU2), wherein the output unit 2 of the first device 1 is connected to the input unit 3 of the second device 1. In addition, the output unit 2 of the second device is connected to the input device 3 of the first device.

As can be seen, the output unit 2 can be implemented via a general-purpose input/output pin (GPIO), which the input unit 3 can be a capture compare unit (CCU), which is operated in capture mode. A counter register incremented with the internal processor clock is reset to zero when the status on the CCU pin changes. The CCU is configured so that the register is only reset with one (either rising or falling) edge of a signal fed to the corresponding pin, but not with both types of edge.

The output unit 2 is designed in such a way that a signal is output on a rising edge of a synchronisation period so that the other device 1 is informed of the start of the synchronisation period (via signalling to the input unit 3).

FIG. 2 explains the procedure for synchronising the two devices 1, as shown in FIG. 1.

Synchronisation takes place alternately in two successive phases: the measurement phase and the adjustment phase.

In the measurement phase, an offset of the synchronisation period (T_{Sync}) to the other device 1 is first determined in a respective device 1, which is then compensated for in the subsequent adjustment phase. This is done by adjusting the synchronisation period (T_{Sync}) by a value dependent on the offset determined.

First, however, the synchronisation period (T_{Sync}) of the two devices 1 must be set, wherein this depends on a period duration of the software running on the first device 1 and the second device 1 respectively. A software period (T_{SW}) defines a work cycle of the respective software, the frequency of which is significantly lower than the clock frequency of the processor used to execute the software.

If the software runs on both devices 1, or microcontrollers, with the same period duration (T_{SW}), then the synchronisation period (T_{Sync}) corresponds to the software period (T_{SW}). If, on the other hand, the software periods (T_{SW}) of the two programs executed by the respective processors of the different devices 1 are different, the synchronisation period (T_{Sync}) corresponds to the least common multiple of the two different software periods (T_{SW}). Accordingly, the following applies:

$${T}_{Sync} = kgV ( {T}_{SW 1} , {T}_{SW 2} ) ,$$

where T_{SW1} is the software period of the software on the first device 1 and T_{SW2} is the software period of the software on the second device 1.

Any correction value ΔT for the synchronisation period (T_{Sync}) can then also be distributed over the respective number of software periods (T_{SW}) for different software periods (T_{SW}).

In FIG. 2, the synchronisation period (TSync) is plotted over time for each of the two devices to be synchronised and the incrementing status of the timer measuring module is shown, which is reset on a rising edge of the synchronisation period of the other device.

In the measurement phase, a signal is output to the other device 1 based on the synchronisation period (T_{Sync}) prevailing in a respective device 1. For this purpose, a signal is sent to the input unit 3 of the other device via the output unit on a rising edge of the synchronisation period (T_{Sync}), which leads to a reset of the counter value of the timer measuring module in the device 1 that receives the signal.

In the example of the first microcontroller MCU1, the rising edge can be recognised at the start, which, represented by a dotted arrow, leads to a reset of the measurement timer module of the second microcontroller MCU2 to a start value, in this case zero.

The measurement timer module of the first microcontroller MCU1 is also reset in a corresponding manner on a rising edge of the synchronisation period (T_{Sync}) in the second microcontroller MCU2, wherein this reset takes place with an offset of ΔT₁.

In each of the two microcontrollers MCU1 and MCU2, the current timer value (counter reading) of the measurement timer module is saved on a falling edge of the associated synchronisation period (T_{Sync}), which is designated as T_{Capture} in FIG. 2. The measurement timer module can be part of a CCU of the device.

In the adjustment phase, the stored timer value of the measurement timer module, which indicates the time between a last reset and a falling edge of the synchronisation period (T_{Sync}), is used to determine a deviation (TΔ) of the device compared to the other device.

There are essentially the different cases shown below, which can be determined using the measured time (T_{Capture}) compared to the synchronisation period in a device:
T_{Capture}˜T_{Sync}; the measured time therefore corresponds exactly to the synchronisation period or has only a slight deviation from it (i.e. is within a specified deviation from the synchronisation period), such that it can be assumed that the two devices or the two microcontrollers are running synchronously or approximately synchronously with each other. An adjustment is not required.
T_{Capture}<T_{Sync}; the measured time is less than the synchronisation period, which indicates that the synchronisation period is “too early”. In FIG. 2, this applies to the first microcontroller MCU1. The duration of the next phase should therefore be lengthened in order to synchronise with the other microcontroller again.
T_{Capture}>T_{Sync}; the measured time is greater than the synchronisation period, which indicates that the synchronisation period is “too late”. In FIG. 2, this applies to the second microcontroller MCU2. The duration of the next phase should therefore be shortened in order to synchronise with the other microcontroller again.
T_{Capture}>2×T_{Sync}; indicates that no synchronisation signal has been detected by the remote side. It is therefore assumed that the remote side is not active and therefore no synchronisation is possible, which is considered an error case.

FIG. 2 shows in the adjustment phase that half of the deviation detected by a microcontroller is compensated for. Since each of the two controllers performs half compensation, wherein one microcontroller lengthens the next phase and the other shortens the next phase, the synchronisation period of the two microcontrollers is synchronised again after the adjustment phase, so that the adjustment phase is followed by the synchronisation period starting at the same time again.

However, the disclosure can also provide that only one of the two microcontrollers makes an adjustment in its synchronisation period, wherein the entire deviation detected must then of course be adjusted. This could be an advantage for the microcontroller, which does not have to adjust its phase, as a corresponding unit for adjusting the synchronisation period is not required here.

Another advantage is that if only one-sided compensation is performed, several participants can synchronise. Although synchronisation is faster with exclusively two-sided synchronisation, only two participants are possible.

If the synchronisation period is not equal to the software period of the software executed on the microcontroller, the value to be corrected can be divided into the respective number of software periods that run during a synchronisation period.

For example, in the case of a microcontroller that compensates for half of the detected deviation, the compensation value can be divided equally between the number of software periods, the sum of which corresponds to a synchronisation period and runs during such a period. As a result, a large number of smaller adjustments are made, which are less disadvantageous than a larger adjustment over a single software period.

The actual implementation of a corrected software period is typically realised by changing a load register in a hardware timer. The synchronisation period is usually also controlled by a timer module, which generates an interrupt when a predefined timer value is reached to signal that the synchronisation period has ended. To start a further synchronisation period, a value from the load register is used, which is responsible for the time until the interrupt signal is output. In order to shorten or lengthen the synchronisation period, the value in the load register is adjusted accordingly so that a deviation from the previous value of the load register results in a shortening or lengthening of the synchronisation period.

In addition, an error can also be detected if the measured time is greater than twice the synchronisation period. Normally, it can be concluded from this, that one of the two internal clocks of the microcontroller is faulty, such that the software cannot be executed with the expected period duration. A watchdog with an independent internal clock is usually used to ensure the real-time behaviour of the software. If the period duration of a software deviates too much, a respective processor is reset or other error handling is initiated. It would then be recognised that the remote station is no longer available due to a deviation (T_{Capture}>2×T_{Sync}).

Furthermore, according to the disclosure, it can also be provided that the values of the measured time T_{Capture} are stored and analysed so that it can be detected whether a deviation is permanently too large. This would indicate that a deviation in the synchronisation of the two devices cannot be compensated for, such that it must be assumed that one of the two sides cannot meet the required synchronisation period (T_{Sync}).

Although it is not possible to determine which side is deviating, a loss of synchronisation can be detected earlier than with a watchdog.

The present disclosure achieves the advantages described above with little effort in terms of hardware and software by using standard components and achieves a very high degree of accuracy.

1. A device for synchronising or adjusting a clock signal for a software, comprising:
a processor for executing the software based on the clock signal, wherein the clock signal defines the start or the end of a software period,
a measurement timer module that increments a timer value based on a device clock,
an output unit designed to output an output signal to a signal output of the device at the beginning of a synchronisation period defined by the software period or a multiple of the software period,
an input unit designed to receive an input signal at a signal input of the device,
a register unit designed to store a current timer value of the measurement timer module at the end of the synchronisation period, and
a comparison unit designed to compare the timer value stored in the register unit with the synchronisation period and, depending on a comparison result, to adjust at least one subsequent period duration of the clock signal for the software executed on the processor,
wherein the measurement timer module is designed to reset the timer value to a start value when the input signal is received.

2. The device according to claim 1, wherein the device clock has a frequency that is greater than the frequency of a clock for executing the software executed on the processor.

3. The device according to claim 1, wherein the comparison unit is designed to lengthen or shorten a subsequent period duration of the clock signal for the software executed on the processor by half the time difference determined by the comparison result.

4. The device according to claim 1, wherein the comparison unit is designed to lengthen or shorten several subsequent period durations of the clock signal for the software executed on the processor by a fraction of a time difference determined by the comparison result.

5. The device according to claim 1, wherein the comparison unit is designed to divide the timer value stored in the register unit by a frequency characterising the device cycle in order to obtain a measurement period.

6. The device according to claim 1, further comprising:
an internal clock timer module that increments a timer value based on the device clock and outputs an interrupt signal when a preset timer target value is reached,
wherein the software period is the preset timer value divided by the frequency of the device cycle, and
wherein the comparison unit is designed to modify at least one subsequent period duration of the clock signal for the software executed on the processor by adjusting the timer target value.

7. The device according to claim 1, wherein:
the input unit is implemented by a capture/compare unit, which is configured in capture mode, and/or
the output unit is implemented by a general-purpose input/output unit.

8. A system for synchronising or adjusting a clock signal of a plurality of software programs executed in parallel, comprising:
a first device, and
a second device,
wherein the first device and the second device are each configured as the device of claim 1, and
wherein the output unit of the first device is connected to the input unit of the second device and the output unit of the second device is connected to the input unit of the first device.

9. The system according to claim 8, wherein the synchronisation period is the least common multiple of the software period of the first device and the software period of the second device.

10. A method for synchronising or adjusting a respective clock signal for a plurality of software programs executed in parallel, comprising the steps of:
defining a respective software period for the plurality of software programs to be synchronised with each other, which are executed by respective computer units, which executes an associated software program,
defining a synchronisation period as the least common multiple of the several respective software periods, and
performing a time measurement, wherein a start time of the time measurement for a first computer unit is the start of the synchronisation period of a second computer unit and an end time of the time measurement for the first computer unit is the end of the synchronisation period of the first computer unit, and wherein the start time of the time measurement for the second computer unit is the start of the synchronisation period of the first computer unit and the end time of the time measurement for the second computer unit is the end of the synchronisation period of the second computer unit,
comparing, by each computer unit, a result of the time measurement with the synchronisation period, and
adjusting at least one subsequent synchronisation period as a function of the comparison.

11. The method according to claim 10, wherein if the software period is equal to the synchronisation period, a subsequent software period is then lengthened or shortened by half of a deviation determined in the comparison.

12. The method according to claim 10, wherein if the software period is N times the synchronisation period, N subsequent software periods are each lengthened or shortened by 1/2N times the value determined in the comparison.

13. The method according to claim 10, wherein a measured value determined in the comparison, an amount of which is greater than twice the synchronisation period, indicates that there is an error.

14. The method according to claim 10, wherein a sequence of comparison results obtained in the comparison is stored and analysed, and when a predetermined threshold value of the multiple comparison results is reached, a fault is inferred via a predetermined number of successively performed comparisons.

15. An aircraft having the device according to claim 1.

16. The device according to claim 1, wherein the device is a microcontroller.

17. The device according to claim 1, wherein the start value is zero.

18. The device according to claim 2, wherein the frequency of the device clock is more than 100 times greater than the frequency of the clock for executing the software executed on the processor.

19. The device according to claim 4, wherein the fraction is
$$\frac{1}{2 N} ,$$
wherein N is the number of subsequent period durations of the clock signal to be lengthened or shortened for the software executed on the processor.

20. The system according to claim 8, wherein a respective software program of the plurality of software programs executed in parallel is executed by the respective processor of the first device and the second device.
